(19) United States
(12) Patent Application Publication
(10) Pub. No.: US 2002/0062485 A1
(43) Pub. Date: May 23, 2002

(54) Cable modem system

(76) Inventors: Eiji Okano, Shinagawa (JP); Takaya Yamamoto, Kawasaki (JP)

Correspondence Address: ROSENMAN & COLIN LLP, 575 MADISON AVENUE, NEW YORK, NY, 10022-2585, US

(21) Appl. No.: 09/818,351

(22) Filed: Mar. 27, 2001

(30) Foreign Application Priority Data
Nov. 20, 2000 (JP) 2000-353412

(51) Int. Cl. H04N 7/173

(52) U.S. Cl. 725/111; 725/105; 725/112

(57) ABSTRACT

In a cable modem system utilizing a DHCP to dynamically allocate an IP address to a subscriber terminal, a DHCP server address notifying portion of a cable modem termination system notifies a cable modem of a DHCP server address, a DHCP relay agent of the cable modem relays DHCP messages as a relay agent, an IP address detector detects the IP address from the DHCP message, an IP address storage stores the IP address, and a packet filtering portion discards a packet having a source IP address other than the IP address stored in the IP address storage when the packet is received from the subscriber terminal.

### BACKGROUND OF THE INVENTION

1. Field of the Invention

The present invention relates to a cable modem system, and in particular to a cable modem system utilizing a DHCP (Dynamic Host Configuration Protocol) to dynamically allocate an IP address to a subscriber terminal.

In recent years, the CATV transmission line has been deemed as an access network, whereby the cable modem systems capable of connecting homes to the Internet through LAN interfaces have been put to practice.

Since the CATV transmission line corresponds to the public access LAN circuit in these cable modem systems, it is particularly required that durability (stability) against the system breakdown and the like caused by a setting mistake of an equipment connected to a cable modem or on purpose, and the security management for the individuals are reinforced. Accordingly, the allocation of the IP address to subscriber terminals is important.

2. Description of the Related Art

Methods of allocating an IP address to a subscriber terminal in the cable modem system include one in which a fixed IP address is manually allocated to the subscriber terminal, and another in which a dynamic (or static) IP address allocation is automatically performed by the DHCP.

FIG. 20 shows a system arrangement of a general cable modem system, in which subscriber terminals 21 and 31 in subscriber homes 20 and 30 are respectively connected, through a CATV transmission line TL, to a CATV center 10 which is further connected to the Internet NW.

At this time, the subscriber terminals 21 and 31 are respectively connected to the CATV transmission line TL with cable modems 200 and 300.

In the CATV center 10, a cable modem termination system 100, a DHCP server 13 for automatically allocating the IP address to the subscriber terminal, various application servers (DNS/Mail/WWW servers) 11 for offering services, and a router 12 for connecting to the Internet NW are connected in the form of LAN with the Ethernet 14.

Also, the cable modem termination system 100 is connected to the CATV transmission line TL through a head-end device 15.

With respect to the IP address allocation, since the cable modem system is a LAN based system as shown in FIG. 20, it is possible that the communication of a subscriber who has been allocated with a regular IP address is disturbed or tapped if a duplication of an IP address is caused by a setting mistake or on purpose. Therefore, the cable modem system is required to be equipped with a mechanism for preventing the duplication of the IP address.

In recent years, the cable modem of the DOCSIS specification standardized in the United States is about to assume the mainstream.

As for the cable modem system of the DOCSIS specification having the arrangement shown in FIG. 20, when fixedly allocating the IP addresses to the subscriber terminals 21 and 31 (manually or by the DHCP statistic allocation), it is possible to perform a filtering (hereinafter referred to as IP filtering) of the IP address in the cable modems 200 and 300 if the allocated IP addresses of the subscriber terminals 21 and 31 are respectively preset in the cable modems 200 and 300 so that only those IP addresses may be used for the communication. Namely, by setting a different filtering for each cable modem, the duplication of the IP address can be avoided.

On the other hand, when dynamically allocating the IP address by the DHCP, the cable modem termination system 100 serves as a DHCP relay agent for performing the IP address allocation.

The cable modem termination system 100 relays DHCP messages transmitted/received between the DHCP server 13 and the subscriber terminals 21 and 31 as the DHCP relay agent. A packet format of the DHCP message is composed of a MAC header, an IP header, a TCP header, a DHCP frame, and a FCS (Frame Check Sequence) as shown in FIG. 21.

Also, a frame format of the DHCP frame has fields such as a message code “OP”, a hardware address type “htype”, and a hardware address length “hlen” as shown in FIG. 22. Among these fields, a “yiaddr” field indicates the IP address allocated to the subscriber terminal by the DHCP server, and a “giaddr” field indicates the IP address of the relay agent.

When the IP address is dynamically allocated by the DHCP, there is a possibility that the IP addresses allocated to the subscriber terminals 21 and 31 are changed on every allocation, so that it is not possible to specify the IP address per subscriber terminal. Therefore, the cable modems 200 and 300 can not perform the IP filtering, and it is not possible to avoid the duplication of the IP address caused by the setting mistakes of the subscriber terminals 21 and 31 or on purpose thereof.

Among the cable modem systems having original specifications before the standardization, some can perform the IP filtering per cable modem so that only the subscriber terminals having the fixed IP addresses may communicate when a specific IP address is allocated to each subscriber. However, in case that a dynamic IP address allocation is performed by the DHCP, it is not possible to perform the IP filtering.

Also, when packets which disturb the communication are transmitted from the subscriber terminal which has acquired the IP address by the DHCP, it is difficult to specify this subscriber terminal by the IP address since the correspondence between the IP address and the subscriber terminal is not recognized.

In order to specify the subscriber terminal which has transmitted the packets which disturb the communication, the management of the MAC address of the subscriber terminal may be also considered. However, since it is necessary to have the subscriber declare every time a LAN card of the connected PC is changed, performing a thorough management is difficult.

In recent years, due to the exhaustion of the IP addresses, it has become very difficult to secure a global address at a rate of one IP address per subscriber. Therefore, there are many Internet service providers who are operating or desiring to operate by allocating a limited number of global addresses by the DHCP.

Among those providers, some providing two kinds of services, one for the fixed IP address allocation and the other for the DHCP allocation, generally have the service rates set cheaper for the DHCP allocation compared with the fixed allocation.

However, in the prior art, it is not possible to recognize when the subscriber who has contracted the use of the DHCP allocated service communicates by manually setting an IP address of the fixed allocation. Therefore, there is a problem that it is not possible to avoid the use of the IP address of the fixed allocation at a cheaper service rate corresponding to the DHCP allocation.

### SUMMARY OF THE INVENTION

It is accordingly an object of the present invention to prevent the subscriber terminal from improperly using an IP address other than an allocated IP address in a cable modem system utilizing a DHCP to dynamically allocate an IP address to a subscriber terminal.

For the achievement of the above object, the cable modem system according to the present invention comprises: a cable modem termination system for connecting a CATV center to a CATV transmission line, a cable modem for connecting each subscriber terminal to the CATV transmission line, a DHCP server for dynamically allocating an IP address to the subscriber terminal by transmitting/receiving DHCP messages to/from the subscriber terminal through the cable modem, the cable modem termination system has a DHCP server address notifying portion for notifying a DHCP server address to the cable modem, and the cable modem has a DHCP relay agent for relaying the DHCP messages as a relay agent, an IP address detector for detecting the IP address from the DHCP message, an IP address storage for storing the IP address, and a packet filtering portion for discarding a packet having a source IP address other than the IP address stored in the IP address storage when the packet is received from the subscriber terminal.

Namely, the cable modem termination system connecting the CATV center to the CATV transmission line notifies all of the cable modems connecting the subscriber terminals to the CATV transmission line of the DHCP server address that is the IP address of the DHCP server itself which dynamically allocates the IP address to the subscriber terminal.

The DHCP relay agent of cable modem relays, as a relay agent, the DHCP messages transmitted/received between the DHCP server and the subscriber terminal by using the DHCP server address notified from the cable modem termination system.

At this time, the IP address detector takes out the IP address allocated to each subscriber terminal from the DHCP message and the IP address storage stores the IP address. Then, the packet filtering portion discards the packet if the packet received from the subscriber terminal has a source IP address other than the allocated IP address.

Thus, the IP address allocated by the DHCP and the subscriber terminal are made corresponding to each other in the IP address storage, so that it becomes possible to prevent the subscriber terminal from improperly using the IP address other than the allocated IP address.

In this case, the IP address and the subscriber terminal are made corresponding to each other in the IP address storage of the cable modem even if the packets which disturb the communication are transmitted by the subscriber terminal which has acquired the IP address by the DHCP. Therefore, it is made possible to specify the subscriber terminal by the IP address by managing the correspondence between the cable modem and the subscriber terminal.

Also, the packet filtering portion in the cable modem system according to the present invention may discard a packet if the subscriber terminal is in a state where an IP address is unallocated by the DHCP server and the packet having the source IP address other than the predetermined initial IP address is received from the subscriber terminal.

Namely, if the subscriber terminal is in the state where the IP address is unallocated, i.e. the state where the IP address is not allocated by the DHCP server, the cable modem relays only the packets having the predetermined initial IP address (e.g. “0.0.0.0”) for the source address among the packets received from the subscriber terminal as the relay agent, and other packets are discarded at the packet filtering portion.

Thus, it becomes possible to avoid the improper use of a fixed IP address in the IP address unallocated state when the subscriber terminal is set to have the IP address allocation by the DHCP.

Therefore, is becomes possible to distinguish between the subscriber terminals having the IP address allocation by the DHCP and having the fixed IP address allocation.

Also, in the cable modem system according to the present invention, the cable modem may have a lease time storage for storing a lease time of the IP address dynamically allocated to the subscriber terminal by the DHCP message, and may clear the IP address stored in the IP address storage after the lease time has elapsed to make the subscriber terminal be in a state where the IP address is unallocated.

Namely, the cable modem takes out the lease time set by the DHCP server for the IP address dynamically allocated to the subscriber terminal from the DHCP message to be stored in the lease time storage, and after the lease time has elapsed, clears the IP address stored in the IP address storage so that the subscriber terminal returns to the state where the IP address is unallocated.

After the lease time assigned for a certain IP address has elapsed, it is possible that the DHCP server allocates the same IP address to another subscriber terminal. Therefore, the cable modem makes the subscriber terminal return to the state where the IP address is unallocated after the lease time has elapsed for the allocated IP address, so that it is made possible to prevent the duplicated IP address.

It is to be noted that after returning the subscriber terminal to the state where the IP address is unallocated, the cable modem discards the packet having the source address other than the predetermined IP address when the packet is received from the subscriber terminal.

Also, in the cable modem system according to the present invention, the cable modem may have a release message detector for detecting a DHCP release message transmitted by the subscriber terminal in order to release the allocated IP address, and may clear the IP address stored in the IP address storage when the DHCP release message is detected to make the subscriber terminal be in a state where the IP address is unallocated.

Namely, upon receiving the DHCP release message transmitted by the subscriber terminal for releasing the allocated IP address, the cable modem detects this message at the release message detector, and clears the IP address stored in the IP address storage to return the subscriber terminal to the state where the IP address is unallocated.

When the subscriber terminal transmits the DHCP release message in order to release the IP address, the DHCP server which has received this message may allocate the released IP address to other subscriber terminal. Therefore, it is made possible to prevent the duplication of the IP address by having the cable modem clear the IP address of the subscriber terminal which has transmitted the DHCP release message and returning it to the state where the IP address is unallocated.

Also, in the cable modem system according to the present invention, the cable modem may have a subscriber terminal address notifying portion for notifying the cable modem termination system of the IP address allocated to the subscriber terminal, and the cable modem termination system may have an allocated address manager for storing the IP address notified by the cable modem corresponding to an address of the cable modem itself, and for renewing its storage and notifying the other cable modem to clear the stored IP address to make the subscriber terminal connected to the other cable modem be in a state where the IP address is unallocated when the address is already stored by a notification from another cable modem

Namely, the allocated address manager of the cable modem termination system stores the IP address allocated to the subscriber terminal notified by the subscriber terminal address notifying portion of the cable modem corresponding to the address of the cable modem itself.

In case the IP address has been already stored by the notification from another cable modem, the allocated address manager renews or updates the address of the cable modem to be made corresponding to the IP address with the address of the cable modem which has made the latest notification, and notifies the cable modem having the previously stored address to clear the stored IP address and to make the subscriber terminal which had the IP address allocated return to the state where the IP address is unallocated.

The DHCP server in the CATV center sets the lease time upon allocation of an IP address to a certain subscriber terminal and can allocate the same IP address to another subscriber terminal after the lease time has expired. Therefore, by having the cable modem termination system perform the above-mentioned operation, the subscriber terminal whose lease time has expired is disabled from using the IP address, so that it is made possible to avoid the duplication of the IP address.

### BRIEF DESCRIPTION OF THE DRAWINGS

FIG. 1 is a block diagram illustrating an embodiment (1) of the present invention;

FIG. 2 is a sequence chart illustrating an operation of the embodiment (1) of a cable modem system according to the present invention;

FIG. 3 is a diagram illustrating a DHCP server notifying packet format in a cable modem system according to the present invention;

FIGS. 4A, 4B, and 4C are flow charts illustrating operation flows of a cable modem shown in FIG. 2;

FIG. 5 is a sequence chart illustrating a manual IP setting prevention operation in an embodiment (2) of the present invention;

FIG. 6 is a flow chart illustrating an operation flow of a cable modem shown in FIG. 5;

FIG. 7 is a block diagram illustrating an embodiment (3) of the present invention;

FIG. 8 is a diagram illustrating a DHCP server notifying packet format in the embodiment (3) of the present invention;

FIG. 9 is a sequence chart illustrating a lease time management operation in the embodiment (3) of the present invention;

FIG. 10 is a flow chart illustrating an operation flow of the cable modem shown in FIG. 9;

FIG. 11 is a block diagram illustrating an embodiment (4) of the present invention;

FIG. 12 is a sequence chart illustrating an IP address release operation in the embodiment (4) of the present invention;

FIG. 13 is a flow chart illustrating an operation flow of the cable modem shown in FIG. 12;

FIG. 14 is a block diagram illustrating an embodiment (5) of the present invention;

FIG. 15 is a sequence chart illustrating an operation of the embodiment (5) of the present invention;

FIG. 16 is a diagram illustrating an example of a DHCP allocated IP address management table in the present invention;

FIG. 17 is a flow chart illustrating an operation flow of the cable modem shown in FIG. 12;

FIG. 18 is a format diagram of a general subscriber IP notifying packet;

FIG. 19 is a diagram illustrating a general prohibited IP packet format;

FIG. 20 is a block diagram illustrating a system arrangement of a general cable modem system;

FIG. 21 is a diagram illustrating a packet format of a general DHCP packet; and

FIG. 22 is a diagram illustrating a DHCP frame format.

Throughout the figures, like reference numerals indicate like or corresponding components.

### DESCRIPTION OF THE EMBODIMENTS

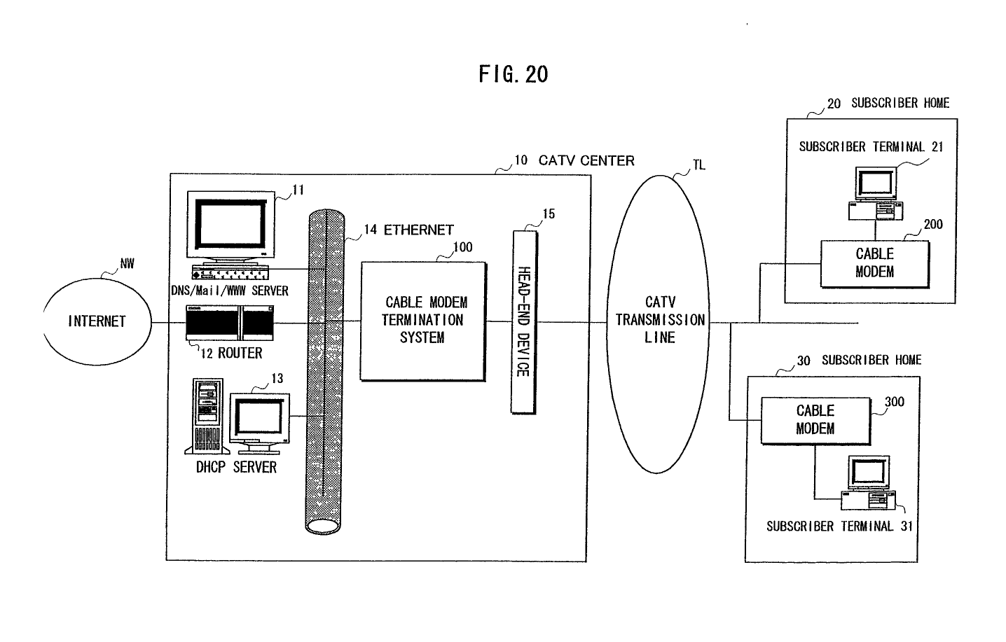

The cable modem system according to the present invention has the same overall arrangement as that of the general system arrangement shown in FIG. 20, and the arrangements of the cable modem termination system 100 and the cable modem 200 (and 300) shown in FIG. 20 are characteristic to the present invention.

It is to be noted that in embodiments (1)-(5) hereinafter described, the LAN within the CATV center 10, shown in FIG. 20, connected by the Ethernet 14 is referred to as a center LAN. Also, the subscriber terminal 21 connected to the cable modem 200 in FIG. 20 is occasionally referred to as a subscriber LAN, since the connection is made to the LAN card of the subscriber terminal 21.

Embodiment (1)

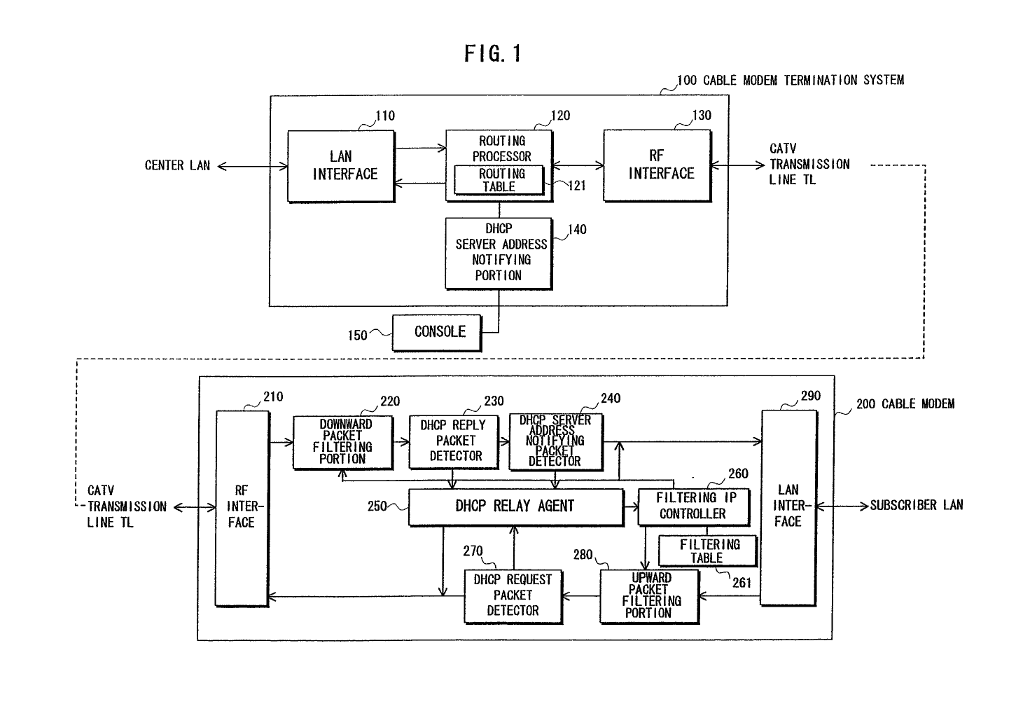

FIG. 1 shows an arrangement of the cable modem termination system 100 and the cable modem 200 in the embodiment (1) of the present invention. It is to be noted that the arrangement of FIG. 1 is also applied to the later described embodiment (2).

As shown in FIG. 1, the cable modem termination system 100 is composed of a LAN interface 110 which is the interface with the center LAN, an RF interface 130 which is the interface with the CATV transmission line TL, a routing processor 120 for performing process of relaying or discarding packets between the LAN interface 110 and the RF interface 130, and a DHCP server address notifying portion 140 for notifying the address of the DHCP server to each cable modem.

Also, a console 150 for making various settings is connected to the cable modem termination system 100. Since the IP address of the DHCP server is set in FIG. 1, the console 150 is shown to be connected to the DHCP server address notifying portion 140.

Also, as shown in FIG. 1, the cable modem 200 is composed of an RF interface 210 which is the interface with the CATV transmission line TL, a LAN interface 290 that is the interface with the subscriber LAN, a downward packet filtering portion 220 for filtering a downward packet transmitted from the cable modem termination system 100 to the subscriber terminal, a DHCP reply packet detector 230 for detecting a DHCP reply packet from the downward packet, an upward packet filtering portion 280 for filtering an upward packet transmitted from the subscriber terminal to the cable modem termination system 100, a DHCP request packet detector 270 for detecting a DHCP request packet from the upward packet, a DHCP relay agent 250 for relaying the DHCP request/reply packets as the DHCP relay agent, a filtering IP controller 260 for detecting the IP address allocated to the subscriber terminal from the DHCP request/reply packets to be managed by the filtering table 261 and for notifying the packet filtering portions 220 and 280 of the IP address for the filtering, and a DHCP server address notifying packet detector 240 for detecting a DHCP server address notifying packet notified by the cable modem termination system 100.

It is to be noted that in the initial state, the downward packet filtering portion 220 is set to pass only the packet addressed to the cable modem 200 itself in which a broadcast address “255.255.255.255” or the IP address “CM” of the cable modem 200 itself is set as a destination address, and the upward packet filtering portion 280 has no IP address set for filtering.

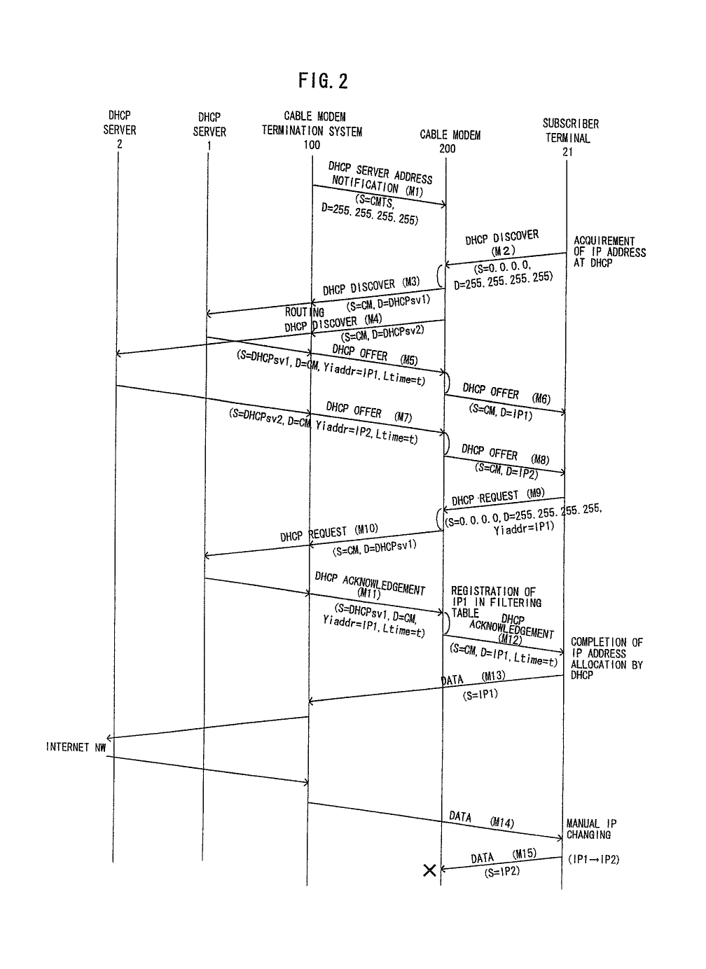

Hereinafter, an IP address allocation sequence in the embodiment (1) will be described referring to FIGS. 1 and 2. It is to be noted that in FIG. 2, DHCP servers 1 and 2 are shown assuming that two DHCP servers 1 and 2 are connected to the cable modem termination system 100 through the Ethernet 14 instead of a single DHCP server 13 shown in FIG. 20. Also, only the cable modem 200 and the subscriber terminal 21 are shown representing the cable modems 200, 300 and subscriber terminals 21, 31 shown in FIG. 20

Firstly, the cable modem termination system 100 broadcasts the DHCP server address notifying packet (reference numeral M1 in FIG. 2, hereinafter, simply referred to as DHCP server address notification) for notifying each cable modem of the IP address of each of the DHCP servers 1 and 2 stored in the DHCP server address notifying portion 140. The DHCP server addresses are preliminarily registered by the console 150 connected to the cable modem termination system 100 and stored in the DHCP server address notifying portion 140.

As a specific operation of broadcasting, the DHCP server address notifying portion 140 sets the stored DHCP server IP addresses in the DHCP server address notification M1 addressed to the broadcast IP address to be transmitted to the RF interface 130. Then, the RF interface 130 transmits the DHCP server address notification M1 to each cable modem 200 (and 300) by broadcasting.

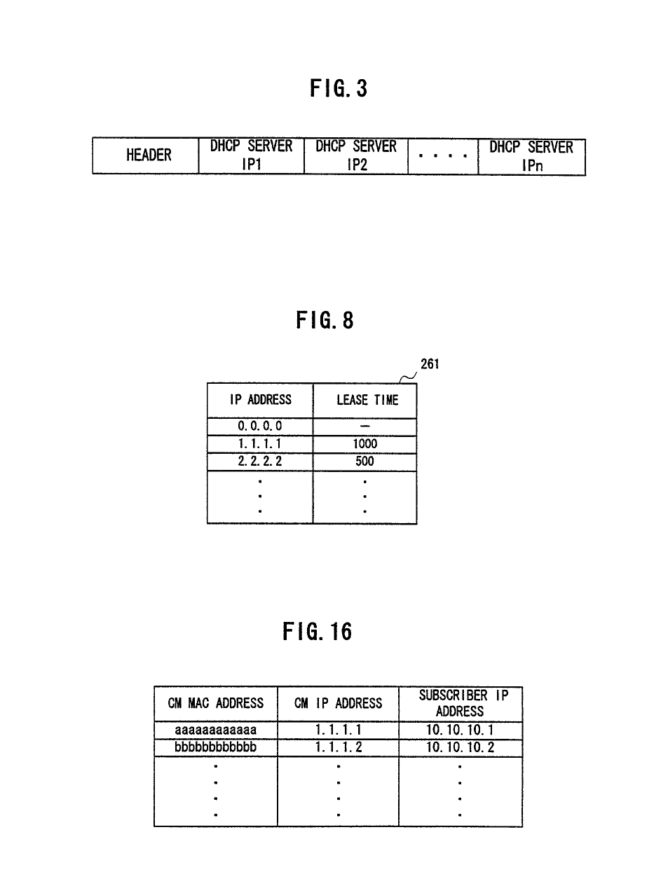

A general packet format of the DHCP server address notification M1 is shown in FIG. 3. Numbers (n) of the DHCP server addresses (two in this embodiment) stored in the DHCP server address notifying portion 140 of the cable modem termination system 100 are set in the single DHCP server address notification M1.

It is to be noted that source and destination addresses of the DHCP server address notification M1 are shown as “(S=CMTS, D=255.255.255.255)” in FIG. 2, which indicates that the source address “S” is the address “CMTS” of the cable modem termination system 100 and that the destination address “D” is the broadcast address.

In the cable modem 200, the DHCP server address notification M1 is received at the RF interface 210, and transmitted to the DHCP server address notifying packet detector 240 through the downward packet filtering portion 220 and the DHCP reply packet detector 230. The DHCP server address notifying packet detector 240 extracts the IP addresses of the DHCP servers 1 and 2 from the received DHCP server address notification M1 to be set in the DHCP relay agent 250.

The subscriber terminal 21 connected to the cable modem 200 is required to set the IP address for accessing the Internet NW. However, the subscriber terminal 21 does not have the IP address allocated by DHCP in the initial state of this embodiment where the IP address allocation is performed utilizing the DHCP.

Therefore, the subscriber terminal 21 broadcasts a DHCP discover packet (hereinafter, simply referred to as DHCP discover) M2 which is the firstly transmitted DHCP request packet, in order to have the IP address allocated by the DHCP server. In the DHCP discover M2, since the subscriber terminal 21 does not have the IP address by the DHCP, the source IP address is “0.0.0.0” which is a fixed value (initial value) common to all subscriber terminals, and the destination address is “255.255.255.255” because of broadcasting.

The cable modem 200 receives the DHCP discover M2 at the LAN interface 290 to be transmitted to the DHCP request packet detector 270 through the upward packet filtering portion 280.

The DHCP request packet detector 270 detects that the DHCP discover M2 is a DHCP request packet and transmits the DHCP discover M2 to the DHCP relay agent 250.

The DHCP relay agent 250 converts the source IP address of the DHCP discover M2 to the IP address “CM” of the cable modem 200 itself, the destination IP addresses to the IP addresses “DHCPsv1” and “DHCPsv2” of the DHCP servers 1 and 2, and sets the IP address “CM” of the cable modem 200 itself in the “giaddr” field indicating that the DHCP discover packet M2 is transmitted through the relay agent to be transmitted to the RF interface 210.

In this embodiment, since a plurality of DHCP servers 1 and 2 are registered, DHCP discovers M3 and M4 are prepared as shown in FIG. 2 and are respectively transmitted to the DHCP servers 1 and 2. The RF interface 210 transmits the DHCP discovers M3 and M4 to the cable modem termination system 100 through the CATV transmission line TL.

In the cable modem termination system 100, the RF interface 130 receives the DHCP discovers M3 and M4 to be transmitted to the routing processor 120.

Since the destination IP addresses of the DHCP discovers M3 and M4 are respectively the IP addresses of the DHCP servers 1 and 2, the routing processor 120 judges that the destination interface is the LAN interface 110 based on the routing table 121 and transmits the DHCP discovers M3 and M4 to the LAN interface 110.

The LAN interface 110 transmits the DHCP discovers M3 and M4 respectively to the DHCP servers 1 and 2.

When respectively receiving the DHCP discovers M3 and M4, the DHCP servers 1 and 2 transmit DHCP offer packets (hereinafter, simply referred to as DHCP offer) M5 and M7, respectively, that are the DHCP reply packets in response to the DHCP discovers and in which IP addresses pooled by the DHCP servers themselves are made temporarily allocated IP addresses and lease times are set.

As shown in FIG. 2, the addresses “DHCPsv1” and “DHCPsv2” of the DHCP servers 1 and 2 are respectively set in the DHCP offers M5 and M7 as the source IP addresses, and the addresses “IP1” and “IP2” are set as the temporarily allocated IP addresses in “Yiaddr” field. Also, the IP address “CM” of the cable modem 200 as the destination IP address and “t” as lease time “Ltime” are set therein.

The cable modem termination system 100 relays the DHCP offers M5 and M7 received from the DHCP servers 1 and 2 to the cable modem 200 since their destination IP addresses are the IP address of the cable modem 200.

In the cable modem 200, when receiving the DHCP offers M5 and M7, the RF interface 210 transmits the offers to the DHCP reply packet detector 230 through the downward packet filtering portion 220.

The DHCP reply packet detector 230 detects that the DHCP offers M5 and M7 are the DHCP reply messages to transmit the offers to the DHCP relay agent 250.

The DHCP relay agent 250 converts the source IP addresses of the DHCP offers M5 and M7 to the IP address “CM” of the cable modem 200 itself, and converts the destination IP address to the temporarily allocated IP addresses to be transmitted to the LAN interface 290 respectively as the DHCP offers M6 and M8.

The LAN interface 290 transmits the DHCP offers M6 and M8 to the subscriber terminal 21.

The subscriber terminal 21 selects one of the DHCP offers M6 and M8, and broadcasts a DHCP request packet (hereinafter, simply referred to as DHCP request) M9 for requesting the use of the temporarily allocated IP address, with the initially fixed source IP address “0.0.0.0”.

When receiving the DHCP request M9, by the same procedure as that for the DHCP discover M2, the cable modem 200 relays the DHCP request M9 to the cable modem termination system 100 as a DHCP request M10.

When receiving the DHCP request M10, the cable modem termination system 100 relays the DHCP request M10 by the same procedure as that for the DHCP discover packet M3 to the DHCP server 1.

When receiving the DHCP request M10, the DHCP server 1 makes the temporarily allocated IP address “IP1” a formally allocated IP address, and transmits a DHCP acknowledgement packet (hereinafter, simply referred to as DHCP acknowledgement) M11 addressed to the IP address “CM” of the cable modem 200.

When receiving the DHCP acknowledgement M11, the cable modem termination system 100 relays the DHCP acknowledgement M11 by the same procedure as that for the DHCP offers MS and M7 to the cable modem 200.

In the cable modem 200, when receiving the DHCP acknowledgement M11, the RF interface 210 transmits the DHCP acknowledgement M11 to the DHCP reply packet detector 230 through the downward packet filtering portion 220. The DHCP reply packet detector 230 transmits the DHCP acknowledgement M11 to the DHCP relay agent 250.

The DHCP relay agent 250 transmits, to the LAN interface 290, a DHCP acknowledgement M12 in which the destination IP address of the DHCP acknowledgement M11 is converted into the allocated IP address “IP1” set in the DHCP acknowledgement M11, and the source IP address converted into “CM”.

Also, the DHCP relay agent 250 notifies the filtering IP controller 260 of the allocated IP address “IP1” for the subscriber terminal 21 set in the DHCP acknowledgement M11.

The filtering IP controller 260 registers the notified IP address “IP1” in the filtering table 261 and notifies the downward packet filtering portion 220 and the upward packet filtering portion 280 of the IP address “IP1” to be passed.

Thereafter, the downward packet filtering portion 220 having received the notification transmits the received packet to the DHCP reply packet detector 230 only in case the destination IP address of the received address is the notified IP address “IP1”, the IP address “CM” of the cable modem 200 itself, the broadcast address, or the multicast address, while discarding the packets in which other destination IP addresses are set.

Likewise, the upward packet filtering portion 280 having received the notification thereafter transmits the packets to the DHCP request packet detector 270 only in case the source IP address is the notified IP address “IP1”, while discarding the packets in which the other IP addresses are set.

Also, the LAN interface 290 transmits the DHCP acknowledgement M12 received from the DHCP relay agent 250 to the subscriber terminal 21.

The subscriber terminal 21 sets the IP address “IP1” and the lease time “t” notified by the DHCP acknowledgement M12, and thereafter performs communication using the set IP address “IP1”.

The subscriber terminal 21 can transmit a packet addressed to the Internet NW in which the source IP address “IP1” is set, for example, a data packet (hereinafter, simply referred to as data) M13. In this case, the data M13 are transmitted to the Internet NW through the cable modem 200 and the cable modem termination system 100.

Also, in case data M14 having set therein the destination IP address “IP1” are transmitted from the side of the Internet NW, the subscriber terminal 21 receives the data M14 through the cable modem termination system 100 and the cable modem 200.

If an IP address different from “IP1” is manually set in the subscriber terminal 21, for example, when the IP address is manually changed from “IP1” to “IP2”, data M15 having the source IP address of the manually set IP address “IP2” are discarded by the cable modem 200, so that the subscriber terminal 21 can not communicate.

Also, the data having set therein the IP address other than “IP1” as the destination IP address will never reach the subscriber terminal 21 from the side of the Internet NW.

Thus, the subscriber terminal 21 can only communicate with the IP address “IP1” set by the DHCP.

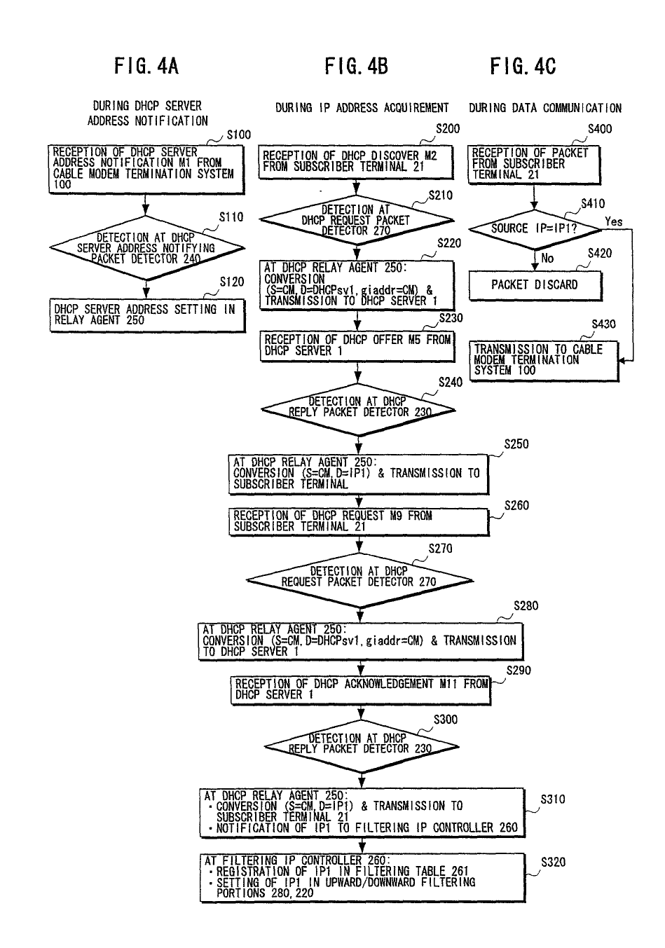

FIGS. 4A, 4B, and 4C show operation flows of the cable modem 200 shown in FIG. 2 in the course of (1) DHCP server IP address notification, (2) IP address acquirement, and (3) data communication, respectively.

(1) In the course of the DHCP server IP address notification, the cable modem 200 receives the DHCP server address notification M1 from the cable modem termination system 100 (at step S100), the DHCP server address notifying packet detector 240 detects the same (at step S110), and the notified DHCP server IP addresses “DHCPsv1” and “DHCPsv2” are set in the DHCP relay agent 250 (at step S120).

(2) In the course of the IP address acquirement, the cable modem 200 receives the DHCP discover M2 from the subscriber terminal 21 (at step S200), the DHCP request packet detector 270 detects the same (at step S210), which is converted by the DHCP relay agent 250 into [S=CM, D=DHCPsv1, giaddr=CM] and then transmitted as the DHCP discover M3 to the DHCP server (at step S220).

When receiving the DHCP offer M5 notifying, for example, the temporarily allocated IP address “IP1” from the DHCP server 1 (at step S230), the DHCP reply packet detector 230 detects the same (at step S240), which is converted by the DHCP relay agent 250 into [S=CM, D=IP1] and then transmitted to the subscriber terminal 21 (at step S250).

When receiving the DHCP request M9 for using the IP address “IP1” from the subscriber terminal 21 (at step S260), the DHCP request packet detector 270 detects the same (at step S270), which is converted by the DHCP relay agent 250 into [S=CM, D=DHCPsv1, giaddr=CM] and then transmitted as the DHCP request M10 to the DHCP server 1 (at step S280).

When receiving the DHCP acknowledgement M11 from the DHCP server 1 (at step S290), the DHCP reply packet detector 230 detects the same (at step S300), and the DHCP relay agent 250 transmits the same, which is converted into [S=CM, D=IP1], to the subscriber terminal 21 and notifies the IP address “IP1” to the filtering IP controller 260 (at step S310).

The filtering IP controller 260 registers the IP address “IP1” in the filtering table 261, and notifies the IP address “IP1” to the upward packet filtering portion 280 and the downward packet filtering portion 220 (at step S320).

(3) In the course of the data communication, when receiving the data 13 from the subscriber terminal 21 (at step S400), the cable modem 200 judges whether or not the source IP address of the data 13 is “IP1” (at step S410) at the upward packet filtering portion 280. If the source IP address is not “IP1”, the data packet is discarded (at step S420). Otherwise the data 13 is transmitted to the cable modem termination system 100 (at step S430).

Embodiment (2)

In the embodiment (2) of the present invention, the arrangements of the cable modem termination system 100 and cable modem 200 are the same as those shown in FIG. 1 for the embodiment (1). However, the cable modem 200 of this embodiment (2) is different from the embodiment (1) in that the upward packet filtering portion 280 is preliminarily notified by the filtering IP controller 260 to discard packets other than the packets having the source IP address of “0.0.0.0” or the packets addressed to the IP address “CM” of the cable modem 200 itself.

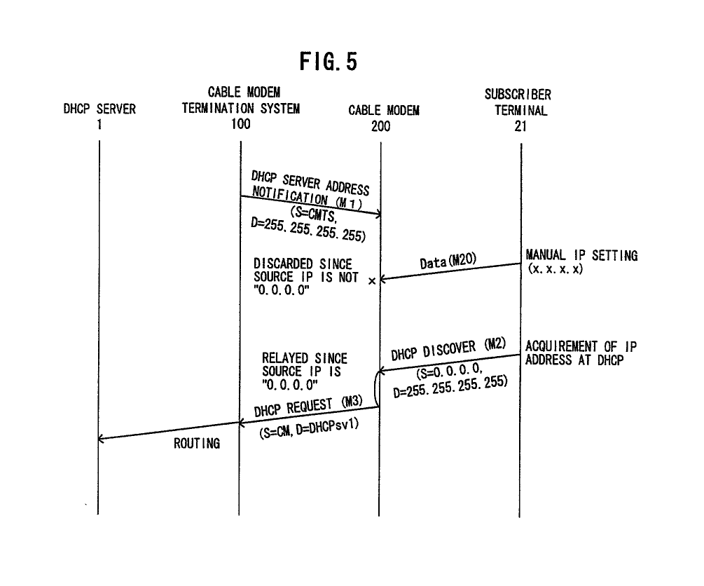

FIG. 5 is a sequence chart for describing a manual IP setting preventing operation of the embodiment (2). In order to simplify the description, the DHCP server 2 and the sequence after the DHCP discover M4 in FIG. 2 are omitted.

In FIG. 5, in case the subscriber terminal 21 tries to transmit data M20 using a manually set IP address “x.x.x.x” after the cable modem 200 receives the DHCP server address notification M1 transmitted by the cable modem termination system 100, since the upward packet filtering portion 280 in the cable modem 200 is set to the initial state to discard the packets which are received from the subscriber terminal 21 having source IP address other than “0.0.0.0” in the embodiment (2), the data M20 is discarded as shown in FIG. 5.

If the DHCP discover M2 in which the source IP address is “0.0.0.0” is transmitted from the subscriber terminal 21, when receiving the DHCP discover M2 in the same way as in the embodiment (1), the cable modem 200 transmits the DHCP discover M3 to the DHCP server 1 and the operation thereafter is the same as that of the embodiment (1).

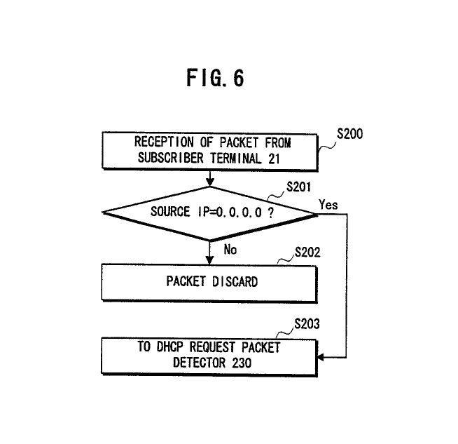

FIG. 6 shows an operation flow of the cable modem 200 when a manual IP setting prevention shown in FIG. 5 is performed. This operation flow of the manual IP setting prevention is for preventing the data communicating operation shown in FIG. 4C from being performed before the IP address acquirement shown in FIG. 4B in case of the embodiment (1).

Firstly, in the cable modem 200, upon reception of a packet from the subscriber terminal 21 (at step S200), the upward packet filtering portion 280 judges whether or not the source IP of the packet is “0.0.0.0” (at step S201). If it is not “0.0.0.0”, the packet is discarded (at step S202). Otherwise it is transmitted to the DHCP request packet detector 270 (at step S203).

Thus, in the embodiment (2), the upward packet filtering portion 280 of the cable modem 200 can prevent the transmission of the packet in which an IP address is manually set to a state before the subscriber terminal receives the IP address allocation by the DHCP.

Embodiment (3)

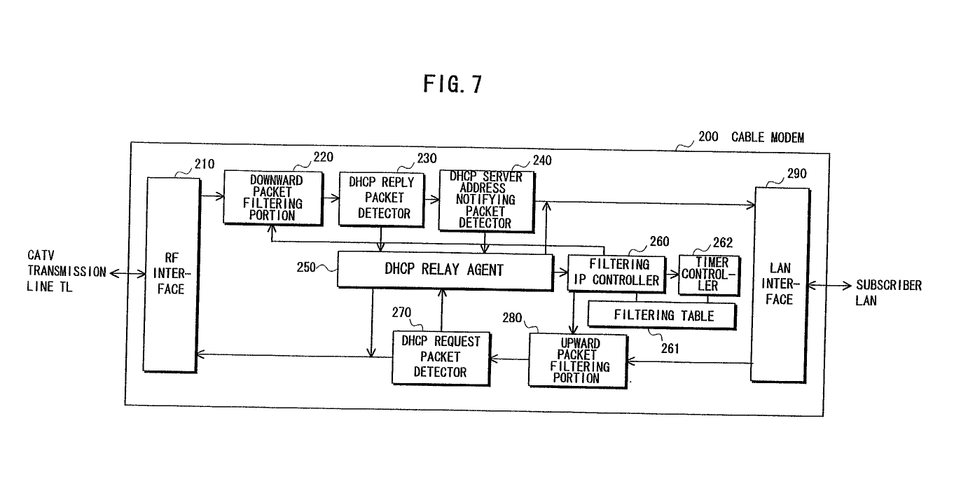

FIG. 7 shows a block diagram of the cable modem 200 in the embodiment (3) of the present invention in which a timer controller 262 is added to the arrangement of the cable modem 200 shown in FIG. 1 for the embodiments (1) and (2). In this embodiment (3), the cable modem termination system 100 may have the same arrangement as that shown in FIG. 1 for the embodiments (1) and (2).

Also, the filtering table shown in FIG. 7 is different from the filtering table 261 shown in FIG. 1 for the embodiments (1) and (2) in that a lease time is added for each filtering IP address.

FIG. 8 shows an example of the filtering table 261 in this embodiment (3), in which the lease time is not set for the IP address “0.0.0.0” since it is not the IP address allocated by the DHCP server 1. However, for example, the IP address “1.1.1.1” has 1000 seconds, and the IP address “2.2.2.2” has 500 seconds respectively set for the lease time.

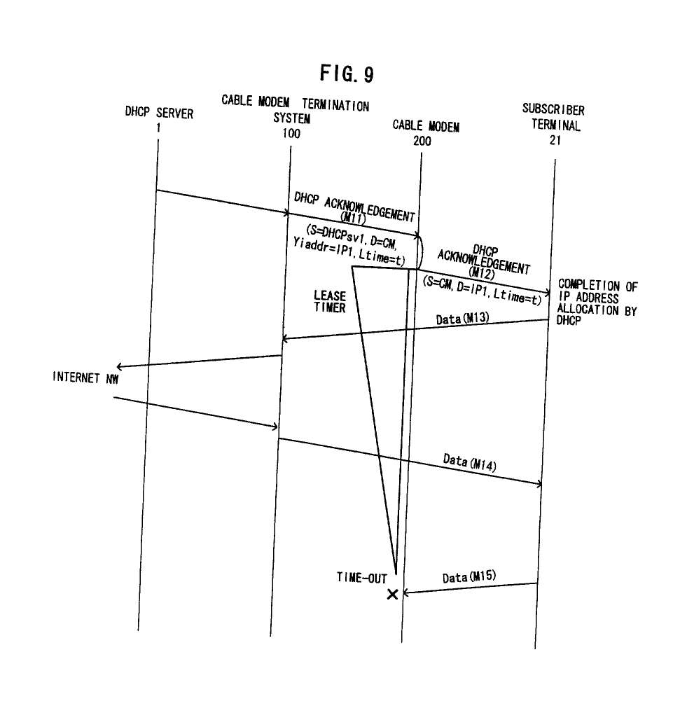

Hereinafter, the lease time management operation of this embodiment (3) will be described referring to FIG. 9. It is to be noted that in FIG. 9, for simplifying the description, the DHCP server 2 and the sequence before the DHCP request M10 in FIG. 2 are omitted.

In FIG. 9, in the same way as the embodiment (1), the cable modem 200 having received the DHCP acknowledgement M11 from the DHCP server 1 stores the IP address “IP1” allocated to the subscriber terminal 21 and the set lease time (Ltime=t) in the filtering table 261.

In the same way as the embodiment (1), upon completion of the IP address allocation by receiving the DHCP acknowledgement M12 from the cable modem 200, the subscriber terminal 21 can transmit the data M13 to the Internet NW or receive the data M14 to the contrary.

Until the lease time “t” elapses, such a transmission/reception of the data similar to the data M13 and M14 between the subscriber terminal 21 and the Internet NW is possible.

In the cable modem 200, the timer controller 262 manages the lease time “t” of the IP address “IP1” in the filtering table 261, so that when lease time “t” expires, the expiration of the lease time (time-out) of the IP address “IP1” is notified to the filtering IP controller 260.

When receiving the time-out from the timer controller 262, the filtering IP controller 260 notifies the upward packet filtering portion 280 and the downward packet filtering portion 220 not to pass the packets having the timed out IP address “IP1” as the source IP address.

Therefore, after the time-out, the downward packet filtering portion 220 discards the packet addressed to the IP address “IP1” and the upward packet filtering portion 280 discards the packet whose source is the IP address “IP1”.

FIG. 9 shows how data M15 are discarded by the cable modem 200 when the subscriber terminal tries to transmit the data M15 after the time-out.

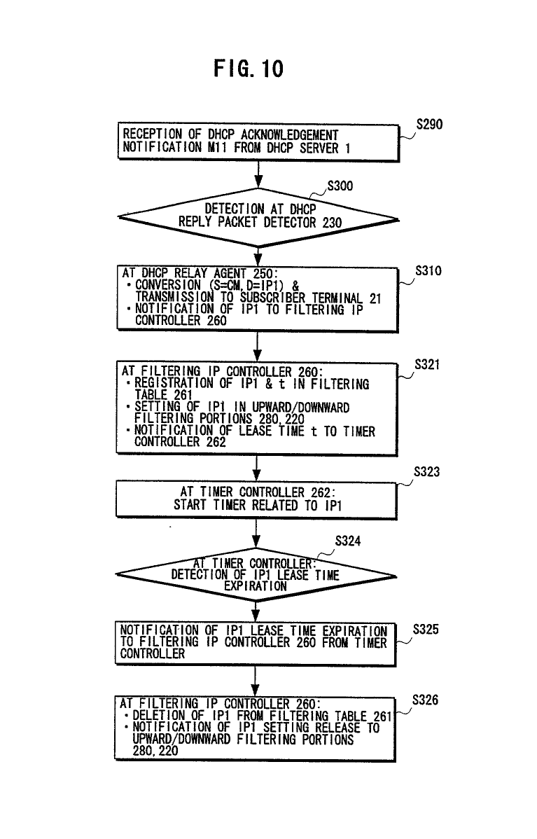

FIG. 10 shows an operation flow of the cable modem 200 when preventing the IP address duplication after the time-out shown in FIG. 9. In FIG. 10, since the operation flow of cable modem 200 corresponding to the steps S200-S280 shown in FIG. 4B for the embodiments (1) and (2) is the same, those steps are omitted.

Hereinafter, the operation flow after step S290 shown in FIG. 10 will be described.

In the same way as the embodiments (1) and (2), upon reception of the DHCP acknowledgement M11 from the DHCP server (at step S290), the DHCP reply packet detector 230 detects the same (at step S300), which is converted by the DHCP relay agent 250 into [S=CM, D=IP1] and then transmitted to the subscriber terminal 21, and the IP address “IP1” is notified to the filtering IP controller 260 (at step S310).

The filtering IP controller 260 registers the IP address “IP1” and the lease time “t” in the filtering table 261, notifies the IP address “IP1” to the upward packet filtering portion 280 and the downward packet filtering portion 220, and further notifies the lease time “t” to the timer controller 262 (at step S321).

The timer controller 262 starts the timer related to the IP address “IP1” (at step S323). After detecting the time-out of the IP address “IP1” (at step S324), the timer controller 262 notifies the time-out of IP address “IP1” to the filtering IP controller 260 (at step S325).

The filtering IP controller 260 deletes IP address “IP1” from the filtering table 261 and notifies the upward packet filtering portion 280 and the downward packet filtering portion 220 to release the setting of the IP address “IP1” (at step S326).

Thus, in this embodiment (3), it is possible to prevent the duplication of the IP address when a certain IP address is allocated to a different subscriber terminal after the time-out.

Embodiment (4)

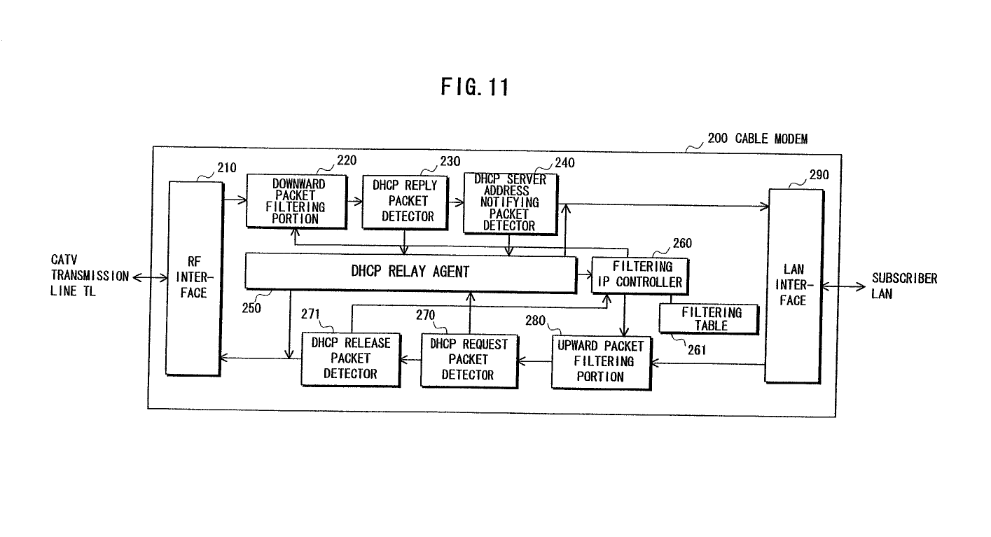

FIG. 11 shows a block diagram of the cable modem 200 in the embodiment (4) of the present invention, where in addition to the cable modem 200 shown in FIG. 1 for the embodiments (1) and (2), a DHCP release packet detector 271 is added for detecting a DHCP release packet (hereinafter, simply referred to as DHCP release) transmitted by the subscriber terminal 21 when the use of the allocated IP address is terminated.

In this embodiment (4), the cable modem termination system 100 may have the same arrangement as that shown in FIG. 1 for the embodiments (1) and (2).

Generally, there are cases where the subscriber terminal transmits a DHCP release M16 when terminating the use of the IP address allocated by the DHCP server 1. It is to be noted that in some cases the DHCP release is not transmitted depending on the state at the time of the usage termination or the kind of the subscriber terminal.

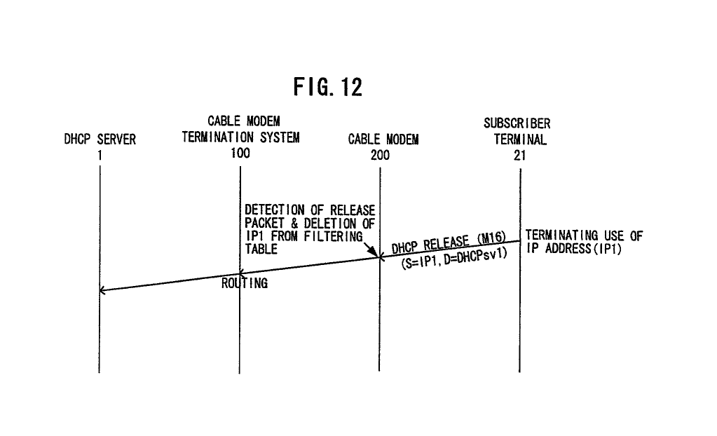

Hereinafter, an IP address releasing operation of this embodiment (4) when the subscriber terminal 21 transmits the DHCP release M16 to terminate the use of the allocated IP address will be described referring to FIG. 12. It is to be noted that FIG. 12 shows the operation after the allocation of the IP address is completed by receiving the DHCP acknowledgement M12 in FIG. 2. However, for the simplification's sake, the DHCP server 2 shown in FIG. 2 is omitted.

When terminating the use of the allocated IP address “IP1”, the subscriber terminal 21 transmits the DHCP release M16 addressed to the DHCP server 1.

When the cable modem 200 relaying the DHCP release M16 receives the DHCP release M16 at the LAN interface 290, it is transmitted to the DHCP release packet detector 271 through the upward packet filtering portion 280 and the DHCP request packet detector 270.

When the DHCP release packet detector 271 receives the DHCP release M16, the IP address “IP1” whose usage is terminated is extracted and notified to the filtering IP controller 260.

The filtering IP controller 260 having received the notification deletes the IP address “IP1” from the filtering table 261 and notifies to the upward packet filtering portion 280 and the downward packet filtering portion 220 not to pass the packet having the IP address “IP1”.

After the notification, the downward packet filtering portion 220 discards the packet addressed to the IP address “IP1” and the upward packet filtering portion 280 discards the packet whose source address is the IP address “IP1”.

When the DHCP release M16 relayed by the cable modem 200 is received by the DHCP server 1 through the cable modem termination system 100, the DHCP server 1 judges that the IP address “IP1” is made available to be allocated to another subscriber terminal.

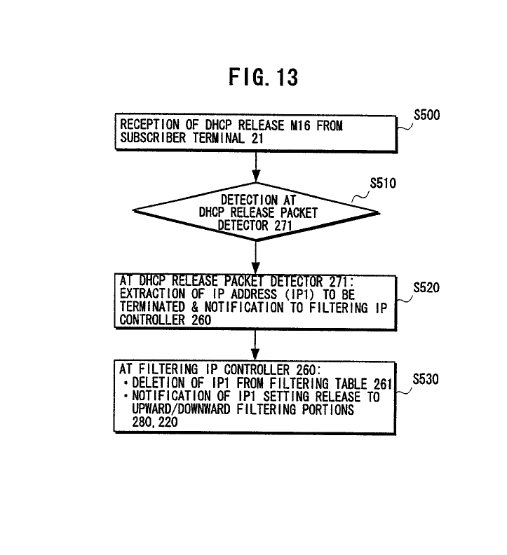

FIG. 13 shows an operation flow of the cable modem 200 at the time of the DHCP release M16 reception shown in FIG. 12.

Upon reception of the DHCP release M16 from the subscriber terminal 21 (at step S500), the DHCP release packet detector 271 detects the same (at step S510), and extracts the terminating IP address “IP1” and notifies it to the filtering IP controller 260 (at step S520).

The filtering IP controller 260 deletes the IP address “IP1” from the filtering table 261 and notifies the upward packet filtering portion 280 and the downward packet filtering portion 220 to release the setting of the IP address “IP1” (at step S530).

Thus, in this embodiment (4), even if the IP address “IP1” made available by the DHCP release M16 from the subscriber terminal 21 is allocated to another subscriber terminal by the server 1, the duplication of the IP address can be avoided since the cable modem 200 performs the filtering of the IP address “IP1”.

Embodiment (5)

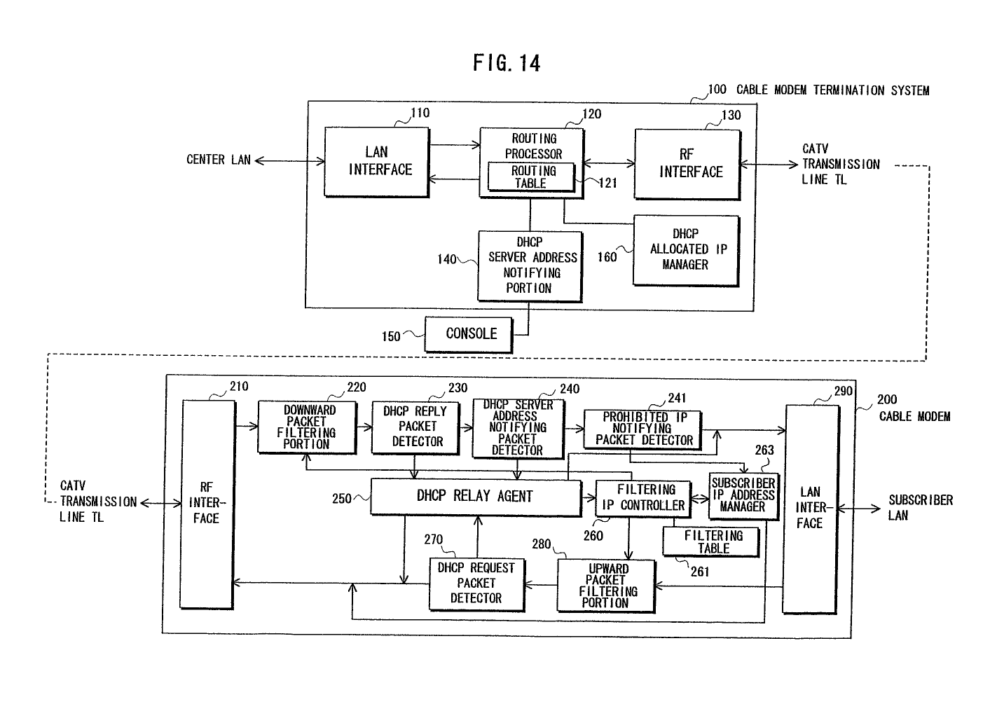

The arrangements of the cable modem termination system 100 and the cable modem 200 in the embodiment (5) of the present invention are respectively shown in FIG. 14.

The cable modem termination system 100 shown in FIG. 14 has an arrangement in which a DHCP allocated IP manager 160 is added to the arrangement of the cable modem termination system 100 shown in FIG. 1 for the embodiment (1). Also, the cable modem 200 shown in FIG. 14 has the arrangement that a prohibited IP notifying packet detector 241 and a subscriber IP address manager 263 are added to the arrangement of the cable modem 200 shown in FIG. 1 for the embodiment (1).

The DHCP allocated IP manager 160 receives the IP address allocated to the subscriber terminal 21 by the DHCP server 1 from the cable modem 200 (or 300), manages with a management table (not shown) so that the IP addresses are not duplicated and notifies, in case of a duplication, the cable modem 200 (or 300) not to pass the duplicated IP address by a prohibited IP notifying packet.

The prohibited IP notifying packet detector 241 receives the prohibited IP notifying packet from the cable modem termination system 100.

Also, the subscriber IP address manager 263 notifies the IP address registered in the filtering table 261 to the cable modem termination system 100, deletes the IP address indicating the transmission prohibited from the filtering table 261 when instructions for prohibiting the transmission are received from the cable modem termination system 100, and thereafter refrain from passing the transmitted/received packets of the subscriber terminal of the IP address.

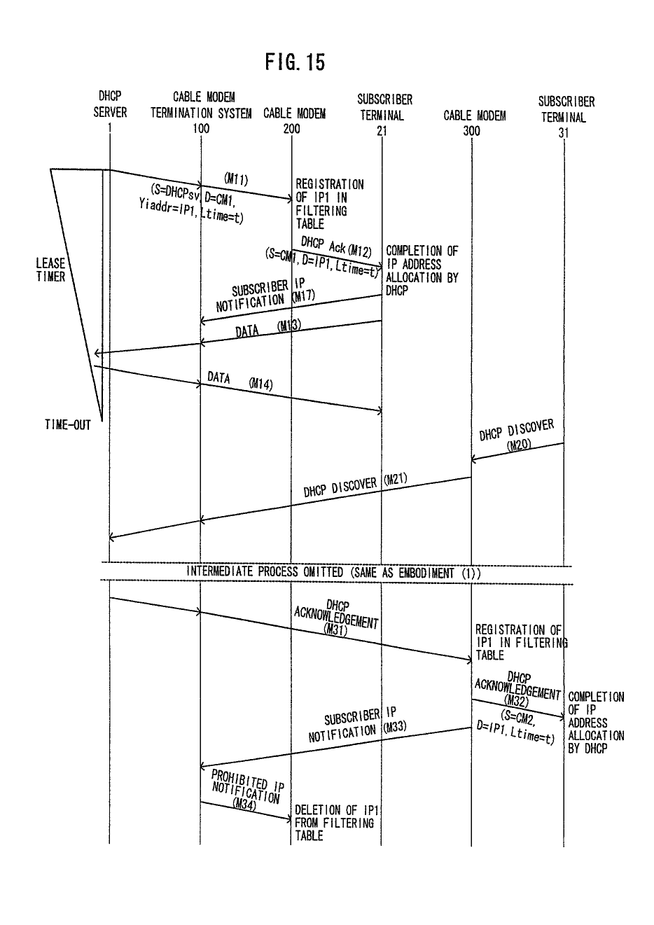

Hereinafter, the operation sequence of this embodiment (5) will be described referring to FIG. 15. It is to be noted that the operation sequence in FIG. 15 is the same as that shown in FIG. 9 for the embodiment (3) except that the cable modem 200 does not manage the lease time. Also, for the sake of description, the cable modem 300 and the subscriber terminal 31 respectively same as the cable modem 200 and the subscriber terminal 21 are additionally shown.

First of all, when the cable modem 200 and the subscriber terminal 21 receive the DHCP acknowledgement M11 in the same way as the embodiment (1), the filtering IP controller 260 of the cable modem 200 adds the IP address “IP1” to the filtering table 261.

At this time, in this embodiment (5), the subscriber IP address manager 263 transmits a subscriber IP notifying packet (hereinafter, simply referred to as subscriber IP notification) M17 addressed to the cable modem termination system 100 in which the added IP address “IP1” is set in the RF interface 210, to be transmitted to the cable modem termination system 100.

When the cable modem termination system 100 receives the subscriber IP notification M17 at the RF interface 130, the routing processor 120 relays the same to the DHCP allocated IP manager 160. The DHCP allocated IP manager 160 judges whether or not the notified subscriber IP address “IP1” is already registered on the management table.

In case of FIG. 15, assuming that the IP address “IP1” is unregistered, the IP address “CM” and the MAC address of the cable modem 200 which is the notification source of the subscriber IP notification M17, and the IP address “IP1” of the subscriber terminal 21 are registered in the management table.

An example of a management table registration at this time is shown in FIG. 16. For example, in case of a cable modem having a MAC address “aaaaaaaaaaaa”, an IP address “1.1.1.1” and an IP address “10.10.10.1” allocated to the subscriber terminal connected to this cable modem are registered.

In general, the DHCP server manages the IP address allocated to the subscriber by the lease time so that within the lease time, the IP address will never be allocated to another subscriber terminal but the IP address whose lease time has expired can be allocated to another subscriber terminal.

The DHCP server 1 shown in FIG. 15 is performing such a management of allocated IP address by the lease time. Therefore, the subscriber terminal 21 having completed the IP allocation by the DHCP acknowledgement M12 can transmit/receive packets to/from the Internet NW by using the IP address “IP1” allocated in the same way as the data M13 and M14 until the time-out of the lease time.

When the IP address “IP1” has timed out, the DHCP server 1 judges that the IP address “IP1” is available.

Therefore, when the subscriber terminal 31 connected to the cable modem 300 transmits the DHCP discover M20, the cable modem 300 transmits a DHCP discover M21 to the DHCP server 1 in the same way as the cable modem 200 in the embodiment (1).

Then, the cable modem 300 finally receiving the DHCP acknowledgement M31 registers the IP address “IP1” in the filtering table 261, and by transmitting the DHCP acknowledgement M32 to the subscriber terminal 31, the allocation of the IP address “IP1” is completed.

Next, the cable modem 300 transmits the subscriber IP notification M33 to the cable modem termination system 100.

In this case, the DHCP allocated IP manager 160 of the cable modem termination system 100 judges that the existing information can be discarded since the IP address “IP1” has been already notified by the cable modem 200 having a different MAC address, and is registered in the management table.

In this case, the DHCP allocated IP manager 160 deletes the already registered entry and registers the newly notified IP address and the MAC address of the cable modem 300 and the IP address “IP1” allocated to the subscriber terminal 31.

Moreover, the cable modem termination system 100 transmits a prohibited IP notifying packet (hereinafter, simply referred to as prohibited IP notification) M33, in which the IP address “IP1” is set, to the IP address of the cable modem 200 which was registered in the deleted entry.

The cable modem 200 having received the prohibited IP notification M33 relays the prohibited IP notification M33 to the subscriber IP address manager 263. The subscriber IP address manager 263 extracts the IP address “IP1”, for which the prohibition is instructed, to be notified to the filtering IP controller 260.

The filtering controller 260 having received the notification, deletes the IP address “IP1” from the filtering table 261 and notifies the upward packet filtering portion 280 and the downward packet filtering portion 220 not to pass the packets having the IP address “IP1” thereafter.

After the notification, the downward packet filtering portion 220 discards the packet addressed to the IP address “IP1”, and the upward packet filtering portion 280 discards the packet whose source is the IP address “IP1”.

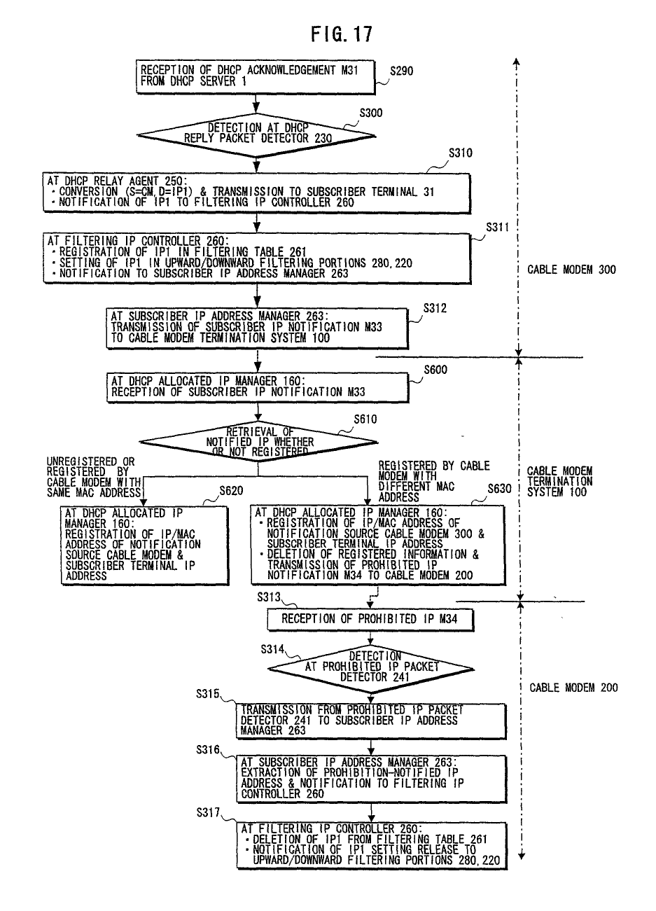

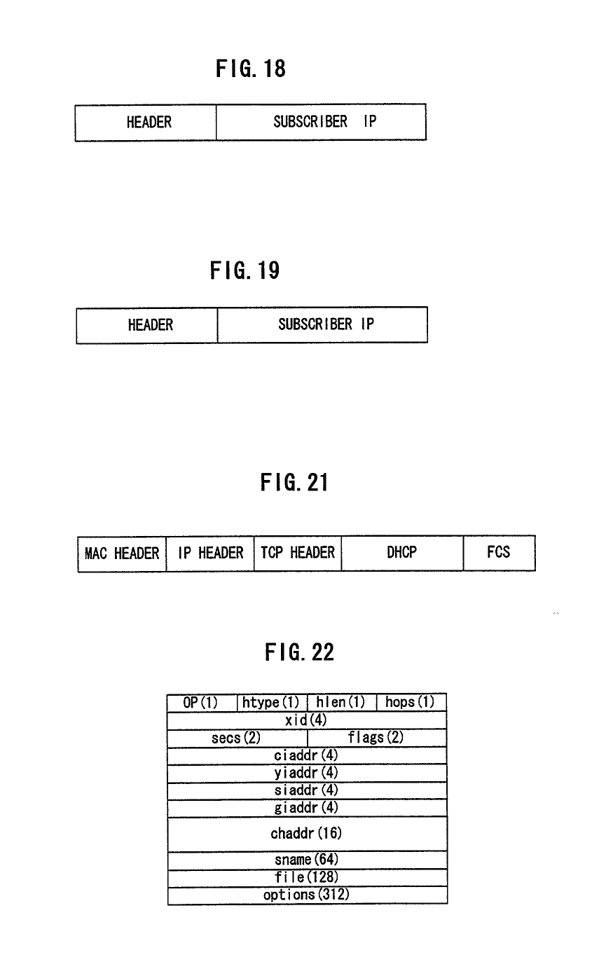

Hereinafter, the operation flow of the cable modems 200 and 300 and the cable modem termination system 100 in this embodiment (5) will be described referring to FIG. 17.

In FIG. 17 steps S290-S312 are the operation flow of the cable modem 300, and the steps S290-S310 are the same operation flow as that of the cable modem 200 shown in FIGS. 4A-C and FIG. 9. Also, steps S600-S630 form the operation flow of the cable modem termination system 100. Moreover, steps S313-317 form the operation flow of the cable modem 200.

After the step S310, the filtering IP controller 260 of the cable modem 300 registers the IP address “IP1” and the lease time “t” in the filtering table 261, notifies the IP address “IP1” to the upward packet filtering portion 280 and the downward packet filtering portion 220, and further notifies the IP address “IP1” to the subscriber IP address manager 263 (at step S311).

The subscriber IP address manager 263 transmits the subscriber IP notification M33 to the cable modem termination system 100 (at step S312).

In the cable modem termination system 100, the subscriber IP notification M33 is received at the DHCP allocated IP manager 160 (at step S600). Whether or not the notified IP address has been already registered by the cable modem with another MAC address is judged (at step S610).

In case the notified IP address is unregistered or already registered by the cable modem with the same MAC address, the DHCP allocated IP manager 160 registers the MAC address and the IP address of the cable modem which is the source of the notification and the IP address allocated to the subscriber terminal (at step S620).

In case the notified IP address is already registered by the cable modem with a different MAC address, the DHCP allocated IP manager 160 registers the MAC address and the IP address of the cable modem which is the source of the notification and the IP address allocated to the subscriber terminal, deletes registered information, and transmits the prohibited IP notification M33 to the cable modem 200 which is the notification source of the deleted registered information (at step S630).

When receiving the prohibited IP notification M33 (at step S313) in the cable modem 200, the prohibited IP notifying packet detector 241 detects and transmits the same to the subscriber IP address manager 263 (at steps S314 and S315).

The subscriber IP address manager 263 extracts the prohibition notified IP address “IP1” to be notified to the filtering IP controller 260 (at step S316). The filtering IP controller 260 deletes the IP address “IP1” from the filtering table 261 and notifies the upward packet filtering portion 280 and the downward filtering portion 220 to release the setting of the IP address “IP1” (at step S317).

Thus, in this embodiment, when the IP address allocated to a certain subscriber terminal is allocated to another subscriber terminal due to the time-out, the subscriber terminal on the timed out side is disabled to use the IP address, so that it is made possible to prevent the IP address from being duplicated.

As described above, the cable modem system according to the present invention is arranged such that a cable modem termination system connects the CATV center to the CATV transmission line, a cable modem connects each subscriber terminal to the CATV transmission line, a DHCP server dynamically allocates the IP address to the subscriber terminal by transmitting/receiving DHCP messages to/from the subscriber terminal through the cable modem, a DHCP server address notifying portion of the cable modem termination system notifies the cable modem of a DHCP server address, a DHCP relay agent of the cable modem relays the DHCP message as a relay agent, an IP address detector detects the IP address from the DHCP message, an IP address storage stores the IP address, and a packet filtering portion discards a packet when the packet having a source IP address other than the IP address stored in the IP address storage. Therefore, it is made possible to prevent the subscriber terminal from improperly using the IP address other than the IP address allocated to the subscriber terminal by the DHCP.

What we claim is:

1. A cable modem system comprising:
a cable modem termination system for connecting a CATV center to a CATV transmission line,
a cable modem for connecting each subscriber terminal to the CATV transmission line, and
a DHCP server for dynamically allocating an IP address to the subscriber terminal by transmitting/receiving DHCP messages to/from the subscriber terminal through the cable modem,
the cable modem termination system having a DHCP server address notifying portion for notifying the cable modem of a DHCP server address, and
the cable modem having a DHCP relay agent for relaying the DHCP messages as a relay agent, an IP address detector for detecting the IP address from the DHCP message, an IP address storage for storing the IP address, and a packet filtering portion for discarding a packet having a source IP address other than the IP address stored in the IP address storage when the packet is received from the subscriber terminal.

2. The cable modem system as claimed in claim 1 wherein if the subscriber terminal is in a state where an IP address is unallocated by the DHCP server, the packet filtering portion discards a packet having the source IP address other than a predetermined initial IP address when the packet is received from the subscriber terminal.

3. The cable modem system as claimed in claim 1 wherein the cable modem has a lease time storage for storing a lease time of the IP address dynamically allocated to the subscriber terminal by the DHCP message, and clears the IP address stored in the IP address storage after the lease time has expired to make the subscriber terminal be in a state where the IP address is unallocated.

4. The cable modem system as claimed in claim 2 wherein the cable modem has a lease time storage for storing a lease time of the IP address dynamically allocated to the subscriber terminal by the DHCP message, and clears the IP address stored in the IP address storage after the lease time has expired to make the subscriber terminal be in a state where the IP address is unallocated.

5. The cable modem system as claimed in claim 1 wherein the cable modem has a release message detector for detecting a DHCP release message transmitted by the subscriber terminal in order to release the allocated IP address, and clears the IP address stored in the IP address storage when the DHCP release message is detected to make the subscriber terminal be in a state where the IP address is unallocated.

6. The cable modem system as claimed in claim 2 wherein the cable modem has a release message detector for detecting a DHCP release message transmitted by the subscriber terminal in order to release the allocated IP address, and clears the IP address stored in the IP address storage when the DHCP release message is detected to make the subscriber terminal be in a state where the IP address is unallocated.

7. The cable modem system as claimed in claim 1 wherein the cable modem has a subscriber terminal address notifying portion for notifying the cable modem termination system of the IP address allocated to the subscriber terminal, and
the cable modem termination system has an allocated address manager for storing the IP address notified by the cable modem corresponding to an address of the cable modem itself, and for renewing its storage and notifying the other cable modem to clear the stored IP address to make the subscriber terminal connected to the other cable modem be in a state where the IP address is unallocated when the address is already stored by a notification from another cable modem.

8. The cable modem system as claimed in claim 2 wherein the cable modem has a subscriber terminal address notifying portion for notifying the cable modem termination system of the IP address allocated to the subscriber terminal, and
the cable modem termination system has an allocated address manager for storing the IP address notified by the cable modem corresponding to an address of the cable modem itself, and for renewing its storage and notifying the other cable modem to clear the stored IP address to make the subscriber terminal connected to the other cable modem be in a state where the IP address is unallocated when the address is already stored by a notification from another cable modem.
